(19) United States
(12) Patent Application Publication
(10) Pub. No.: US 2008/0131842 A1
(43) Pub. Date: Jun. 5, 2008

(54) Multiple grip dental handle

(76) Inventor: Steven Joseph Edwards, Laguna Niguel, CA (US)

Correspondence Address: STETINA BRUNDA GARRED & BRUCKER, 75 ENTERPRISE, SUITE 250, ALISO VIEJO, CA, 92656, US

(21) Appl. No.: 10/965,490

(22) Filed: Oct. 14, 2004

Related U.S. Application Data
(60) Provisional application No. 60/511,497, filed on Oct. 14, 2003.

(51) Int. Cl. A61C 3/00

(52) U.S. Cl. 433/215; 16/111.1

(57) ABSTRACT

A multiple grip handle for dental and other hand-held oral hygiene implements, the handle being adapted to render the implement to which it is applied useable by individuals who have difficulty in firmly grasping a conventional oral hygiene implement handle, difficulty manipulating and stabilizing a handle during oral hygiene, or by individuals who have varying types of preferred grips. The multiple grip handle in the preferred embodiment is fabricated of thermoplastic with an elastomeric coating material having good cushioning, non-slipping, and antimicrobial properties. The handle also has a variable elliptical cross section, a central cavity to socket a brush neck or other equipment, a unique thumb/knuckle grip on the dorsal surface, a plurality of gripping elements on the ventral surface, and an extended distal portion to afford fine control, comfort and stability for whatever gripping style the user prefers.

This invention is unique in that it is reverse-engineered and designed from the perspectives of ergonomics, sports, fitness, and disability as well as from a hygiene perspective. It was designed by forming a moldable material into multiple oral hygiene and dental fitness grip styles superimposed onto each other such that a multiple grip handle resulted that is especially applicable to toothbrushes but may also be adapted to other oral hygiene devices and possibly even other household implements that must be manipulated by hand. A unique dental fitness routine was designed, which resulted in further refinements to the handle. Oral hygiene has been redefined as dental fitness and the invention thus becomes a new type of oral hygiene device called a dental fitness device. The invention is stocky enough to eventually incorporate many types of modifications internally and externally. It is the first oral hygiene device ever designed that advances the concept of hygiene into fitness and is the basis for a proposed line of upcoming dental fitness products. The handle can turn almost any toothbrush and insertable toothbrush neck into a dental fitness device. Very importantly, this invention addresses the issues of self-inflicted cavities and gum problems as well as the naturally occurring ones and aims to help prevent both types of problems more effectively than prior art.

### CROSS REFERENCES TO PRIOR ART

I list only four references at this time because there are innumerable patents probably related:

Provisional Patent Application, Multigrip Dental Handle, 60/511,497 by Steven J. Edwards, Oct. 14, 2003

Universal Handle for Hand-Held Implement, U.S. Pat. No. RE37,190 by Stowell and Callahan, Dec. 4, 1992

Brush Handle, U.S. Pat. No. 6,108,869 by Meessman, et al., Feb. 14, 1996

The Radius Toothbrush Radius, 207 Railroad Street, Kutztown, Pa. 19530, toll.free—800 626-6223

Colgate Total toothbrush, Colgate Oral Pharmaceuticals, One Colgate Way, Canton, Mass. 02021, 1-800-2COLGATE

### FEDERALLY SPONSORED RESEARCH

Not applicable

### SEQUENCE LISTING OR PROGRAM

Not Applicable

### BACKGROUND OF INVENTION

1. Field of Invention

This invention relates generally to hand-held oral hygiene implements which to be used effectively must be securely grasped by the user, manipulated in precise movements, and maintain stability in multiple positions. More particularly, this invention relates to a multiple grip handle applicable to such implements to ergonomically render them usable by individuals who:
because of physical or other disabilities have difficulty in firmly grasping, manipulating, and stabilizing a conventional oral hygiene device
exhibit vastly differing hand gripping styles
wish to convert a standard dental hygiene implement into a high performance dental fitness device

The main thrust of this invention and the preferred embodiment applies to toothbrushes because toothbrushes are the most complex oral hygiene devices in terms of their fabrication, scope of use, function, etc.; however, the handle may also apply to tongue scrapers, gum massagers, periodontal irrigation jets, and other hand held oral devices.

In addition, for the purposes of this invention, oral hygiene is redefined as “dental fitness” because fitness better connotes the advanced principles of ranges of motion, ergonomics, paths of motion, proper technique, follow-through, and other sports-related concepts that are essential for the creation and understanding of a new class of oral health implements that I call “dental fitness devices”.

2. Status of Prior Art and Prior Concepts

Although this invention seems like a basic idea on the surface, there needs to some background explaining the rationale for this invention and how the invention was created, because the concepts behind the invention are the main reason for the invention, and the concepts themselves are contrary to popular belief. In addition, the invention utilizes dental fitness, which is a new principle of operation, and the results of the invention are new, unusual and superior compared to the status quo.

a. Human Factors Engineering and Sports/Fitness Design

Human factors engineering or ergonomics is an applied science that deals with the interaction between devices and their users, taking into account the capabilities or limitations of these individuals. It seeks to match the nature of the device to the physical and cognitive abilities of the user. Human factors engineering must safely match the device with the size, strength and shape of the user and how the user intends to employ the device.

While typical toothbrush manufacturers have focused mainly on bristles, bristle heads, and flexible toothbrush necks, little attention has heretofore been paid to human factors engineering, especially in handle design. Whether in flat or round form, contoured, or in any other configuration, most toothbrush handles are normally not difficult to grasp when the user's hands are reasonably strong and free of impairment. Hence, in the past, far greater attention has been paid to the ornamental or aesthetic features of handle design than to its truly ergonomic aspects. However, there is vastly more to a toothbrush handle than merely creating an aesthetic look or even a comfortable grasp, just as there is certainly more to creating a ski than merely strapping a flat strip of some type of material to a comfortable shoe. In fact, some skis contain microelectronics to heat the snow beneath the blades, and some tennis racquets contain piezoelectric fiber netting to transform kinetic energy into electrical energy in order to stiffen the webbing for a stronger ball return. Therefore, the object is about not only comfort and aesthetics; it is about function, comfort, safety, ergonomics, high performance, and dozens of other requirements. Thus, in many ways, toothbrush technology is far behind sports and fitness technology and desperately needs to catch up.

Sports and fitness design is a subset of human factors engineering relating to the paths and ranges of motion of the human body, joints, muscles, skin, etc., in the act of sports and exercise, and creates products that interact with the body to prevent injury and enhance the fitness effect. In designing the handle for a toothbrush, for example, the designer must understand that the brush will be exposed to toothpaste, bath soap, shampoo, water, microbes, dropping, pressure, twisting, torque, slippage, specific dental fitness routines, storage, travel, electricity, harsh chemicals, body fluids, competition from other products, limited store shelf space, need for identification, etc. In addition, the brush will inadvertently touch other oral tissues such as gums and may possibly even damage soft and hard tissues if used improperly.

Thus, the configuration of the brush and the material of which it is made must not only clean the dental structures and afford a firm grip, but also prevent damage to oral structures, and be multifunctional—that is to say—allow for various brushing pressures, angles, handgrip styles, paths of motion, and ranges of motion. This is a great deal to ask of a toothbrush, especially if the brush is designed for mere hygiene. Imagine a ski designed to go only straight down a hill without consideration for flexing, turning, negotiating bumps, becoming airborne, stopping, etc. A limited ski such as this would be similar to the prior and current state of toothbrushes and toothbrush handle technology.

In the past, America has focused on youth, but in today's world, about 33 million adults are senior citizens. Aging Baby Boomers are 77 million strong. Just these two groups comprise over 100 million Americans, about half of whom are already disabled in some way, according to the Association for Disabled Americans. Many of these disabled people have problems performing activities of daily living that affect their ability to perform oral hygiene properly. Many more people are becoming disabled daily, and everyone who lives long enough eventually becomes at least differently abled. In addition, young children are often unable to brush properly, and many young adults are unmotivated and could not care less about oral hygiene. Therefore, people of all ages, abilities, and cognition comprise a huge group ranging from “differently-abled” to disabled people who may find the simple act of clenching the fingers around a toothbrush handle difficult, painful, clumsy, or uninteresting, not to mention having trouble trying to control the handle and brush during a specific oral hygiene (dental fitness) routine, and then trying to remember the name and style of the brush when the time for replacement comes. Thus, toothbrush design must go beyond aesthetics and even past ergonomics to the point of sports and fitness design, as well as addressing the needs of consumers, marketing, advertising, excitement, disposal of the device, or maybe even different uses after it has served its dental life. The whole big picture from the manufacture, marketing, sales, actual use, and eventual discard and replacement must be considered, with the main focus being on the function of dental fitness. If we focus on fitness, virtually everything else falls into place.

b. Dental Fitness Vs. Oral Hygiene, a Contrarian Concept

Until the recent past, oral hygiene device manufacturers have dealt mainly with the concept of hygiene and have only recently considered factors such as safety, ergonomics, and abrasion. There have been many recent attempts to create safer brushes that do not abrade teeth and gingival tissue, handles that supposedly allow a more controlled or comfortable grip, and flexible neck brushes that supposedly prevent excess force on the dentition. However, the focus has still been on hygiene, which I believe eventually will prove to be a limited viewpoint. Trying to create new oral hygiene devices while maintaining a focus on hygiene is much like trying to create new exercise equipment with the singular focus of building muscle. Without consideration for joint and ligament stresses, safety, ergonomics, ease of use, etc., exercise equipment can actually be dangerous. Instead, it is suggested to reverse-engineer by taking the extreme demands of a high performance device or activity and making that device or activity consumer friendly, comfortable, ergonomic, easy, simple, convenient, safe, automatic, etc. This is what needs to be done in oral hygiene. By looking at oral hygiene as an extreme sport or intense fitness program, and letting the function define the device, new dental prevention devices can be created. The forces of overzealous brushing, the complicated cognitive and physical demands of dental fitness, and the cognitive and physical disabilities of users can be transformed into user-friendly, comfortable devices that are truly safe and easy to use while maintaining oral hygiene as well. Interestingly, dental fitness begets oral hygiene automatically and safely, but oral hygiene does not necessarily beget dental fitness or safety. In fact, a focus on hygiene alone can actually damage teeth and gums irreversibly because hygiene does not follow fitness protocols such as paths of motion, ergonomics, ranges of motion, and so forth. This is just one reason why a new concept of dental fitness must supercede oral hygiene and why new oral hygiene or dental fitness devices must be created.

Dentistry also should replace the outmoded “oral hygiene” concept with the new vision of dental fitness, because food, fatness, fitness and dental health are intricately related. According to the American Dental Association and the Surgeon General's office, 75% of American adults currently suffer from some form of gum disease, and cavities are on the rise in some demographic groups. America's oral health is in great need for improvement. Americans are also the world's fattest people and getting fatter. 62% of Americans are now overweight due mainly to lack of activity, ineffective activity, easy access to junk foods, improper focus on carbs or fats instead of proper nutrition and exercise, super size fast food meals, or excess food in general. All this food plus lack of activity can lead to obesity. All food must pass through the oral cavity on its way into the body. Excess food plus lack of dental hygiene activity can lead to cavities and gum disease. Thus, obesity and dental diseases are intricately related via food.

Worse yet, recent research reveals that poor dental health has links to heart disease, strokes, diabetes, vascular diseases, and more. In some people, poor dental health may actually be life threatening. America has approximately 150,000 dentists (one for approximately every 2000 people—a reasonable amount) and Americans have been doing oral hygiene ever more regularly since World War Two, yet we still have a high rate of gum disease, and cavities are still on the rampage; therefore, neither dentistry nor hygiene seems be the answer for controlling dental problems. Since people spend 100% of their time with themselves but relatively little time at the dentist, and most people eat 5-7 times per day (including snacks), and 75% of any fitness program is comprised of nutrition and supplementation, a new concept of dental fitness should replace oral hygiene because fitness includes nutrition, supplementation and exercise, which are the three main things that Americans need to learn to improve their health. Since people visit dentists more often and more regularly than they visit physicians, learning about fitness through dentists via dental fitness could be a big step in the improvement or our nation's dental and physical health. Furthermore, with dental links to serious systemic diseases, dentists are now finding themselves as a first responder to prevent serious systemic diseases and may actually play an increasing role in helping save lives. But they cannot do it on their own. The people need to help themselves out, and that is mainly where dental fitness, with its new concepts, applies.

It is beyond the scope of this document to discuss in detail all the concepts of dental fitness; however, just as physical fitness and proper nutrition are essential for physical health, dental fitness and proper nutrition are essential for dental health. Briefly stated, dental fitness is the application of the scientific principles of exercise physiology, ergonomics, paths of motion, ranges of motion, cognition, follow-through, sports science, nutrition, supplementation, and more to oral hygiene. This approach can be used to create a new class of dental prevention implements that are called dental fitness devices.

c. Brief Overview of Dental Fitness:

For the purposes of this invention, dental diseases in very general terms can be divided into two classes: 1) naturally occurring or disease-related and 2) unnaturally occurring or trauma-related. Furthermore, dental prevention is viewed from a fitness perspective instead of a hygiene perspective.

Naturally occurring dental diseases result from genetic factors, microbial factors, carelessness, lack of hygiene, poor diet, etc.

Unnaturally occurring diseases result from factors such as accidents, vices, habits, trauma, bulimia, self-infliction, iatrogenic causes, etc.

Interestingly, almost everyone past the age of mid 20s who performs oral hygiene on a regular basis exhibits some form of self-inflicted trauma to the hard and/or soft oral tissues. This trauma shows up as tooth abrasion and gum recession resulting from years of improper and/or overzealous oral hygiene efforts. These self-inflicted problems are the unnaturally occurring alter egos of the naturally occurring cavities and gum disease mentioned above, and they are just as important because they lead to the same serious sequelae as the naturally occurring diseases. Improper oral hygiene and overzealous brushing cause a domino effect of tooth abrasion, gum recession, sensitive teeth with exposed roots, root decay, gum and tooth abscesses, unnecessary pain and suffering, and expensive dental restorations or loss of teeth. With the recent discovery of links between poor dental health and serious systemic conditions such as diabetes, heart disease, stroke, pneumonia, and pre-term low birth-weight babies, it is essential that good dental health be maintained. It is ironic that the act of trying to prevent dental problems can actually lead to more dental problems, partially because most toothbrushes and other oral hygiene devices up to this date are not well ergonomically designed, and the focus has been on hygiene instead of fitness. Worse yet, these types of dental problems are preventable or at least far more preventable than the microbial dental problems, of which most are preventable as well.

In fact, one could argue that the self-inflicted problems are worse than the natural ones because they are caused by innocent, well-meaning people who are trying to avoid dental problems, and these self-inflicted problems are actually more preventable than the microbial problems. It is much like people who over-exercise and cause permanent injury in an ineffective attempt to become more healthy and fit. This can be solved by redesigning toothbrushes as dental fitness sporting devices and dental offices teaching “dental fitness routines” as opposed to hygiene routines. It makes sense to try to prevent problems that are truly preventable, because in doing so, we may also make big progress against the microbial diseases.

A good physical fitness program should include at least ten critical components:
1. Motivation
2. Nutrition
3. Supplementation
4. Aerobic exercise
5. Resistance exercise
6. Core stability and balance
7. Stretching
8. Rest
9. Personal training
10. Professional care

When these ten components are applied to oral hygiene, dental fitness is the result, and we suddenly have an orderly set of rules with which to guide the development of new dental products. A dental fitness program requires a fitness device that heretofore has not existed. A multiple grip dental fitness device was thus created in an attempt to fit the above ten fitness components and to fulfill several additional requirements that are listed in the section entitled Objects and Advantages.

3. Objects and Advantages

The multiple grip dental handle includes the following objectives and advantages:
To provide an ergonomic, multiple grip or multiple grip handle for oral hygiene implements such that the handle can safely transmit operational forces regardless of the grasping styles and motions of the users while performing oral hygiene, the advantage of which affords superior protection of dentition, reduced hand fatigue, reduced gripping pain, ease of use, etc.
To apply principles of fitness, ergonomics, and sports design to oral hygiene devices so as to create a new class of oral hygiene devices called dental fitness devices, the advantage of which includes all of the above advantages and affords the ability to open up a new field of dental prevention products more personally designed, with selectable functions, etc.
To apply principles of fitness, ergonomics, and sports design to oral hygiene procedures for the development of a new concept in oral hygiene called dental fitness, affording the advantage of demystifying and clarifying a confusing subject. By viewing the nebulous subject of oral hygiene from a fitness perspective, suddenly an orderly, scientific, new process that makes total sense and gets positive results becomes crystal clear. Furthermore, dental fitness could be a foot in the door toward physical fitness, and could even save lives, considering links of poor oral health to serious systemic diseases.
To utilize the new devices according to the new principles of operation called for in dental fitness, the advantages being that oral hygiene will occur safely and automatically by default, people could save time and money, people could avoid unnecessary dental problems and suffering since about 80% of common dental problems are preventable, dental restorations will last longer, people might be more willing to invest in their dental health if they know that their teeth and restorations could give longer-lasting service, dentists might perform more advanced treatment if such treatment could be better maintained—in short—everyone wins.
To create said handle that is an integral part of an entire toothbrush
To create an ergonomic, stocky dental handle that can accept the inclusion of additional operative elements to enhance its functions and to afford the ability to be modified in ways yet to be conceived.
To create said handle as a separate inexpensive unit that can be affixed to standard oral hygiene implements, thus transforming such implements into ergonomic dental fitness devices, the advantage of which might be that users could continue to use their favorite oral hygiene device(s) by simply adding the handle element and then disposing of the entire combination at the recommended intervals, or by removing and saving the handle for re-application to a replacement oral hygiene or other implement.
To create a multiple grip handle that might also be applicable to other household handheld devices requiring ergonomics, fine control, stability, comfort, safety, etc.
To be ergonomically and sportily designed for maximum comfort, function, safety, and control for the vast majority of people of differing abilities
To universally fit at least the four major toothbrush gripping styles as well as virtually any other reasonable toothbrush gripping style imaginable and to apply to various other oral hygiene devices as well as possibly other hand-held implements as mentioned above
To aid in the performance of at least one specially designed ultimate dental fitness routine
To allow adequate room for identification, marketing, aesthetics, serial numbers, model numbers, stiffness ratings, size numbers, and other standout features that make it easy for consumers to locate in a crowded supermarket aisle and know what item to replenish after the store packaging is discarded or the product wears out. Unlike sporting devices, almost all oral hygiene aids lack any distinguishing features or special identification to help consumers identify what exact product they are using. A person with a tennis hobby can state exactly what type, style, make, size, etc. of racquet they prefer but a person who brushes several times a day can rarely state exactly what brush they use because when the packaging is discarded, there is nothing left to remind the consumer anything about the device.
To be exciting, interesting, economical, fun, safe, dramatic, simple, easy, automatic, no-brainer, memorable, save time, etc.
To create a stocky and large enough handle to accept the incorporation of an elastomeric, limited slippage, cushioning, textured, grip enhancing material that can also include an antimicrobial substance to limit growth of unwanted organisms

Most self-inflicted tooth abrasion and gum recession occurs in the molar to cuspid region. This is where the dental arch curves from the posterior region to the anterior region. Because most people saw back and forth without bending their wrist or turning their head, this part of the dental arch suffers extensive trauma, much like a rushing curving river erodes riverbanks. With the current art of toothbrushes, not only are people brushing too hard and sawing back and forth on their teeth and gums, but also the bristle head grinds into the dental arch curvature and scours away dental tissue as the arch tries to push the brush head and neck outward. Thus, tooth-brushing force travels down the neck to a relatively immovable handle held in the overzealous brusher's hand. Therefore, prior art brushes give teeth a double whammy of destruction, from the handle and from the brush head and the arch curve. Furthermore, most supposedly flexible neck brushes do not truly reduce brushing forces even though the necks can bend slightly. This is similar to an automobile that weighs the same even when it travels over a bumpy road. The force of gravity on the vehicle never changes despite the wheels bouncing up and down. Similarly, brushing force against teeth does not actually reduce when the toothbrush neck flexes because nearly all flexible neck brushes exhibit Hookian Spring characteristics, meaning that the force increases proportional to the distance displaced. Thus, when the neck is displaced a distance 2× from its normal position, the force on the bristles is actually double, unless a non-Hookian spring in the neck is used.

When using the swivel-thumb or swivel-finger grip, the invention allows the brush handle to swivel with minimal pressure as arch curve force transmits down the neck into the handle. This invention helps minimize dental destruction by accommodating arch curvature, stiff hands and stiff necks in the brush and the user.

The invention is also a disability device because of the aforementioned accommodations, and since it is virtually a no-brainer, cognition problems are not an obstacle.

Gum surgery requires ultra soft brushing force. This invention can maintain an ultra soft brushing force especially when using the swivel-thumb or swivel-finger grip. This brush is essential for the health of periodontal surgery patients.

Aids and cancer victims often suffer vicious oral ulcers. This brush can benefit these patients.

The multiple grip dental handle can make electric brushes safer. One concern regarding increased use of inexpensive electric brushes is that, despite less force needed to remove more plaque than with a manual brush, there is no guarantee that people will actually use less force when brushing with an electric brush. It is highly probable that people will not appreciably change their brushing force or technique when using an electric brush; therefore, most electric brushes could actually become power tools to severely abrade teeth and gums worse than a manual brush could. Think of an electric sander compared to a hand sander. The multiple grip handle can allow better control, proper brush orientation, and safer operation of an electric brush.

One more example comes to mind regarding the contrarian results of an evolved design that affords a valuable function. The negative heel technology behind the “Earth Shoe” was developed after the inventor observed footprints in sand and how the heel imprint was always lower than the rest of the foot imprint, and how posture improved when this design was applied to a shoe sole. In some ways, the multiple grip dental handle could be thought of as being the product of negative thumb/knuckle/finger technology whereby imprints in a moldable substance on an oral hygiene device were transformed into a multiple grip dental handle that affords improved ergonomics in oral hygiene and dental fitness similar to how an “Earth Shoe” enhances posture.

### SUMMARY

In view of the foregoing, the main object of this invention is to provide a handle that can accept multiple gripping styles and is designed from a sports and fitness perspective such that it is ergonomically adapted to render toothbrushes and other similar oral hygiene and dental fitness devices usable by virtually all individuals, who brush in all manners and styles, while recognizing that at least adult and child sizes may be needed. The handle can be designed into a complete oral hygiene or dental fitness device, or as a stand-alone object into which a toothbrush neck can be socketed, or as a stand-alone device that can be accept standard toothbrushes thus enhancing their function. The handle's stockiness allows space for incorporation of other elements to enhance its function or to be designed into an electric oral device.

### DETAILED DESCRIPTION

### Preferred Embodiment Description and Operation

For a better understanding of the invention, reference is made to the following detailed description to be read in conjunction with the accompanying drawings, wherein a toothbrush is depicted including a multiple grip handle in accordance with the invention.

A multiple grip handle in accordance with the invention is applicable to any toothbrush or other oral hygiene implement that includes an extension from the handle that must be manipulated in some way. Hence, though the multiple grip handle's preferred embodiment will, by way of example, be illustrated as applied to toothbrush, the handle is by no means limited to these implements but may be applied to various other oral hygiene devices such as tongue scrapers, flossers, dental picks, periodontal irrigators, and furthermore, may even find some use in household implements such as hammers and screwdrivers, garden tools, bottle openers, kitchen knives, potato peelers and cheese knives.

A general concept in human factors design prefers amorphous handles without knurled or definitive indents for fingers because the indents might be spaced improperly for many people and could actually interfere with correct gripping. However, in this case of reverse-engineering, during repeated attempts of subjecting formless lumps of moldable material to multiple exposures of many functions and gripping styles, a plurality of uniquely spaced and shaped indents and elevations always evolved in basically the same locations for a thumb, index and ring or pinkie fingers and a palm. These indents are not necessarily considered gripping knurls, rather, they are more like stops, rests, gripping pads, or control features that naturally evolved to comfortably manipulate the handle more precisely and maintain control, thus they are considered ergonomically relevant. In this invention they will be named gripping sites or elements. The exact locations, sizes and shapes of these gripping elements are hard to describe in terms of geometric and concrete terms, however, they always evolve in the same general sizes, shapes and locations when a moldable substance is manipulated in multiple gripping styles by an average adult human hand and employed in oral hygiene and dental fitness regimens.

Referring now to FIGS. 1 and 2, shown therein is a toothbrush provided with a multiple grip handle in accordance with the invention. This device includes an array of bristle clusters 1 formed of nylon filaments, Tynex®, or similar material, the clusters being anchored in a synthetic plastic bristle head 2 having an extension neck 3. Neck 3, is joined securely socketed in, or as an extrusion of handle 4.

Handle 4, has a variably ovoid cross section that is bilaterally symmetrical along the long axis centerline of the handle, but asymmetrical along the short axis of the handle.

Toothbrush manufacturers know in detail the types of plastics and elastomers used in toothbrushes. Many of the patents from large companies become very specific about even the code names and grades of materials. So, some of the materials for the invention can be found in recent prior art invention documents. Some examples of materials are polyamides and polypropylenes. The handle is generally manufactured of a thermoplastic material, such as Polypropylene® or Novolene® 1100 HX, from BASF, with a Shore R hardness value in the range of 97 to 100. A polyamide named Ultramid® B3 from BASF Company in Germany is a possible choice. Covering the handle is an elastomeric, limited slip, friction-grip coating such as Neoprene®, Santoprene®, styrene butadiene rubber, butyl rubber, ethylene rubber, plasticized PVC, silicone, ethylene vinyl acetate copolymer or other synthetic rubber, and having a Shore A hardness scale between 5 and 30, preferably around 20, to give the handle a soft, comfortable, cushioned feeling. This coating is textured and thickened in various regions for additional cushioning, slip prevention, and traction control. The toothbrush neck could be made of Nylon® or composite carbon fiber. Bristles may be made of Tynex®. Micro-Ban® may be incorporated into the entire structure to fight microbial contamination.

The handle is stocky, and its dimensions are related to those of the typical adult hand, so that when the handle is clenched by the fingers of the hand, the resultant fist has an internal region that conforms to the contours of the handle.

The nature of jointed fingers is such that when a fist embraces a stocky handle, the internal region of the fist has a generally ovoid cross section that conforms to the shape of the handle. However, since the handle must perform in multiple grip variations, the ovoid shape becomes variable along the long axis of the handle.

The neck is securely inserted into the handle and is bonded thereto by a suitable epoxy or other bonding agent, or the neck may simply be a continuation of the thermoplastic handle material itself.

The bristle head 2 can be a continuation of the neck material or be connected to the neck 3 via a snap attachment 6 on the neck 3. If employing a snap, in this way, the user can obtain more value from the handle by simply replacing worn out bristle heads. This is better for the environment all around when considering manufacturing resources, waste, economics, etc.

Formed in the dorsal midline surface of handle 4 adjacent its proximal end are undulated gripping pad regions 5a, 5b and 5c, whose outlines are best seen in FIG. 1 and FIG. 2. The peripheries of these regions generally conform to the tips and knuckles of the thumb and forefinger in various grip styles. In the undulated thumb/knuckle/finger dorsal gripping pad region 5a and 5b is an array of equi-spaced, textured surface elevations enhancing the dorsal grip site and serving as a means to further enhance the controlling and gripping capability of the handle.

A significant feature of a handle in accordance with the invention is the presence of this unique thumb/knuckle/finger grip region which allows force to be safely and controllably applied through the handle and onto the dentition much like a modern automobile's drive train transmits power from engine to wheels via universal joint, limited slip differential, planetary gears, suspension, etc., but without all the accompanying hardware.

This unique gripping region evolved in a way somewhat analogous to the development of the Colgate “Total” toothbrush several years ago. Colgate Palmolive Co. affixed sensors on the arms, hands, and heads of test subjects who were assigned to brush their teeth in many different ways. A computer recorded and averaged their brushing motions. A toothbrush bristle head design was evolved from the averages in an attempt to orient toothbrush bristles for adequate brushing in virtually any brushing angle, while considering the limitations of manual dexterity. The result was the unusual Colgate “Total” toothbrush. With its splayed bristles radiating out from the bristle head, it looked almost like a brush that been stepped on, or one that you would think had been used for several months already and should be thrown away immediately. At that time, the “Total” bristle head design seemed to violate traditional brush head design, but has since proven to be a fairly effective brush head, especially for people with limited mobility or cognitive problems, even though the handle is not ergonomically designed. The bristle head was a contrarian design because the thinking at that time was that toothbrush bristles should exit straight out of the bristle head and that splayed bristles were less effective plaque removers than straight bristles. However, the design afforded unexpected, improved results, as splayed bristles removed significant plaque with less attention to manual dexterity.

I have applied a similar process to a toothbrush handle. A moldable material was applied to a toothbrush handle. The moldable material was grasped in every conceivable grip and manner of holding and manipulating a toothbrush, specifically including the four most common ergonomic grip styles mentioned below in the section describing the drawings. Various brushing routines were also performed, including a specially designed, highly efficient, ultimate dental fitness brushing routine. As all of the various resultant gripping pressure points, voids, elevations and indents blurred and blended into an overall average, the unusual eventual shape that evolved out of the moldable material became the form of the handle. In this way, a handle capable of accepting many types of grasping styles was evolved from the performance of a series of processes, functions and handgrips instead of trying to design a handle to perform in a certain manner. Thus, a contrarian design is the result, in part, from a new principle of operation called dental fitness, with unexpected, superior results. Instead of merely creating a lumpy, unwieldy handle, as one might expect, a unique and specific shape arose which affords high ergonomics, precision operation, high stability, and excellent function overall. Therefore, the shape of the handle and its unique functional features were heretofore unknown and actually unknowable until the handle eventually evolved from being put to use in multiple ways.

The main result of this process and the single most important feature of the handle is the discovery that a main undulated thumb/knuckle/finger gripping pad region FIGS. 1, 5a and 5b evolved near the midline dorsal proximal end of the handle adjacent to the toothbrush neck. This special, main undulated region is the key feature in fine control, comfort, and stabilization of the grip, and allows the means for such extraordinary versatility. Said main undulated gripping region provides a means of comfortably and precisely manipulating the handle as much as 270 degrees around its long axis and up to 180 degrees about its short axis such that a dental fitness or oral hygiene routine can be performed around the entire internal and external peripheries of each dental arch with minimal hand, wrist, mouth and head movement and even employing as few digits as just a thumb and two fingers if desired. If one could imagine a toothbrush and handle as an automobile and a toothbrush bristle head as similar to the wheels of said automobile, for operation of the handle, this undulated region of the handle is similar to a universal joint, and limited slip differential in an automobile, without which an automobile would have serious problems negotiating anything but straight, flat, frictional surfaces. In essence, the main dorsal undulated gripping region becomes the handle's hypothetical universal joint, planetary gear and limited slip differential pivoting off of whatever digit happens to be in that gripping site, while the other undulated gripping regions on the ventral and dorsal surfaces become the handle's hypothetical active-handling suspension, antilock brakes, and shock absorbers with the remaining digits and palm gently flexing independently to absorb and balance out the forces of brushing and negotiating the curves of the dental arches.

The main undulated thumb/knuckle/finger dorsal gripping pad region is comprised of three unique and important features:
1) a depressed half-oval area FIG. 1, 5a about the size of an average adult human thumb and surrounded on the lateral and proximal peripheries by a raised rim 5i describing a half-oval shape which fades into the body of the handle, thus forming one wall of a bilateral, horizontally oriented V-shaped, rounded channel 5j and a means of stabilizing the device and orienting it optimally toward the dentition while helping guide a knuckle, thumb, or index finger into a comfortable, stable position
2) a raised thumb/knuckle/finger guide bump FIG. 1, 5b at the middle midline distal portion of said half-oval depression 5a that further affords a means of creating outstanding stability and bracing when tilting the brush along its long and short axes, and further defines the previously mentioned horizontally oriented V-shaped channel 5j by creating an opposing wall of the channel
3) a horizontally oriented V-shaped, rounded channel 5j with its apex facing the proximal end and the channel being defined by the intersection of the previously mentioned half-oval area 5a and thumb/knuckle/finger guide bump 5b such that the channel flows seamlessly distally into both lateral surfaces, providing an excellent means of support, comfort and control of the handle and optimal orientation toward the dentition in virtually any type of grasp and during rotation around its long and short axes.

Other key features of the handle body are the raised ends FIG. 2, 5g at the distal end of the handle, opposite from the toothbrush neck, for positive gripping by the “pinkie” (little finger) or the ring finger to prevent slippage of the brush if water, excessive toothpaste foam, bath soap, shampoo, etc., overcome the anti-slip properties of the elastomeric grip.

Additional features in FIG. 2 include three more depressed areas 5c, 5d, and 5e for the index finger and thumb in different grip orientations, as well as large areas 5h, 5f for the palm, middle finger and ring finger.

In FIG. 2, undulations 5d, 5e, 5f, and 5g form ventral grip sites that oppose the main dorsal grip site, 5a and 5b. The ventral grip sites form a means of additional fine control, stabilization, support and comfort for the handle. Again, all these other gripping sites are like the suspension, shocks, and brakes of a car.

Another important feature of the handle is its relative stockiness, so that a user who has difficulty in making a tight fist can make enough of a fist in clenching the handle with his/her fingers to firmly engage the handle. In addition, an advantage of the handle, which is fabricated of a thermoplastic material and covered with an elastomeric, non-slip, antimicrobial substance, is that has both cushioning and exceptional gripping properties, thereby minimizing any pain that may be experienced in grasping the handle and at the same time stabilizing the device. In fact, the device need not be gripped especially hard and can actually be controlled with just a couple of fingertips and a thumb tip if necessary. Another aspect of the stockiness is that it can provide room for a hollow space large enough for incorporation of weights, batteries, electronics, motors, oscillators, magnetorrheostatic fluid, springs, driveshafts, sensors, tension adjusters, flexing necks, standard toothbrush handles, and all sorts of additional equipment to modify the device into an electric brush or allow for balancing, extra stability, additional functions, etc.

As an example of one type of grip, when, as shown in FIG. 5, a user grasps handle 4 with the fingers of his hand 7, the handle is then nested within the palm of the hand. Fingers 9, 10, 11 and 12 are then clenched about the handle to form an open fist whose internal cavity matches the variable ovoid form of the handle. The thumb 8 is pressed into the dorsal grip site on one side of the handle, while the forefinger 9 and pinkie finger 12 or ring finger 11 are pressed in the grip sites on the opposing ventral side to enhance the user's grasp on the handle.

Hence, even a user who is incapable or has difficulty in making a tight fist nevertheless gains a good grip on the multiple grip handle that is further enhanced by the dorsal and ventral grip sites.

The multiple grip handle not only affords a good grip on the implement, but because it is of elastomeric material, it acts to cushion the hand of the user to minimize any pain that might be experienced in handling the implement. Such material, unlike hard plastic or metal, has non-slip characteristics, so that the fingers clenching the handle even when the grip is weak, do not slide on the surface of the handle.

The variably ovoid cross section of a handle in accordance with the invention enhances the user's ability to control lateral rotation of the handled implement. Thus with a toothbrush having a conventional small diameter round or small cross-section flat handle, it is difficult to controllably move the bristle head around the curvature of the dental arch without continual slippage or rotation of the handle in the user's grasp. But with a handle in accordance with the invention, the stocky, ovoid handle and its grip sites prevent slipping in the hand of the user when manipulating the brush around the dental arch.

The length of the handle in accordance with the invention and the rounded shape of its end are such that the end fits the palm of the user's hand and the user can therefore comfortably apply a force in the longitudinal direction of the implement. This is of advantage when, for example, the implement is a tongue scraper and needs extra length to reach the back of the tongue. Moreover, the handle is longer than conventional oral hygiene implement handles in order to prevent the palm and little finger from dangling off the end of the handle, which happens with most toothbrushes currently on the market. In addition, the neck should be longer than other toothbrush necks currently on the market in order to allow better brushing of the furthest back molars or the lower anterior teeth so that the knuckles of the fingers do not bump against the nose and lips. A longer handle combined with a longer neck provides increased fine tactile control, enhanced comfort, and exceptional handling capabilities.

Taking all these features into consideration means that a unique, multiple grip dental fitness handle has been created that can comfortably and precisely support almost any hand grip as well as almost any manner of oral hygiene or dental fitness routine. Moreover, this handle may be applied to other types of oral hygiene and dental fitness devices that require fine control and comfortable gripping.

### Additional Embodiment Description and Operation

Alternatively, in another embodiment, the handle could simply be a Microban®-treated, flexible, elastomeric, limited-slip, molded add-on for existing toothbrushes to provide a means of converting existing standard toothbrushes into dental fitness devices. The multiple grip handle's internal cavity would allow the insertion of a standard toothbrush handle such that the neck of a standard toothbrush emerges from the proximal portion of the handle and the dorsal surface of the multiple grip handle faces away from the toothbrush bristles. The handle would operate in the same way as the preferred embodiment, except that instead of keeping a handle/toothbrush neck combination and throwing away disposable bristle heads, the user could keep the elastomeric handle but remove and throw away the standard toothbrush that was inserted into the handle. Alternatively, if the elastomeric handle were inexpensive enough, the entire inserted brush and elastomeric handle could be disposed of every three months according to current toothbrush disposal recommendations.

In fact, in its simplest form, the handle could simply be a solid elastomeric material that can be molded around many existing types of toothbrushes to turn them into true dental fitness devices.

### BRIEF DESCRIPTION OF DRAWINGS

In sports, there may be many ways to play a particular game, but there may be only a few realistically ergonomic, safe, logical, effective ways to play the game and hold a fitness device such as a bat, racquet, or club. Likewise, in dentistry, there may be many ways to perform oral hygiene and hold a hygiene implement, but only a few methods are truly efficient, effective, logical, safe, etc. I take the position that despite the countless ways that people may find to hold a toothbrush and to brush their teeth, only about four ways of gripping a dental instrument make sense from an ergonomic and fitness perspective. Even though the multiple grip handle was designed for many types of handgrips, only the four most effective and common grips will be presented here. Luckily, these four grip styles allow the formation of a handle that can accommodate many other styles, even if these others are not very sensible. In addition, even if these other grips are not sensible, the handle design helps make almost any grip more comfortable and useful.

FIG. 1 is a perspective view
1 Bristles
2 Bristle head
3 Neck
4 Handle
5a Thumb/knuckle/finger depression
5b Thumb/knuckle/finger guide bump
5i Half-oval rim
5j horizontally oriented V-shaped channel
5c Index finger depression
6 Snap attachment for removable bristle head

FIG. 2 is a left side view
1 Bristles
2 Bristle head
3 Neck
4 Handle
5b Thumb/knuckle/finger guide bump
5i Half-oval rim
5j horizontally oriented V-shaped channel
5c Index finger depression
5d Thumb gripping element
5e Index finger gripping element
5f Finger/palm area
5g Little finger gripping elements
5h Palm/finger area
6 Snap attachment for removable bristle head

FIG. 3 is a proximal and distal view

FIG. 4 is a dorsal view

FIG. 5 shows a swivel-thumb up-tilt picture
4 Handle
7 Hand
8 Thumb
9 Index finger
10 Middle finger
11 Ring finger
12 Pinkie finger

FIG. 6 shows a swivel-thumb down-tilt picture

FIG. 7 shows a swivel-finger grip much like a swivel-thumb grip

FIG. 8 shows a thumb-under grip

FIG. 9 shows a thumb-over grip

FIG. 10 depicts the device in action on the left side of the mouth using swivel thumb up tilt grip

FIG. 11 depicts the device in action on the right side of the mouth using swivel thumb down tilt grip

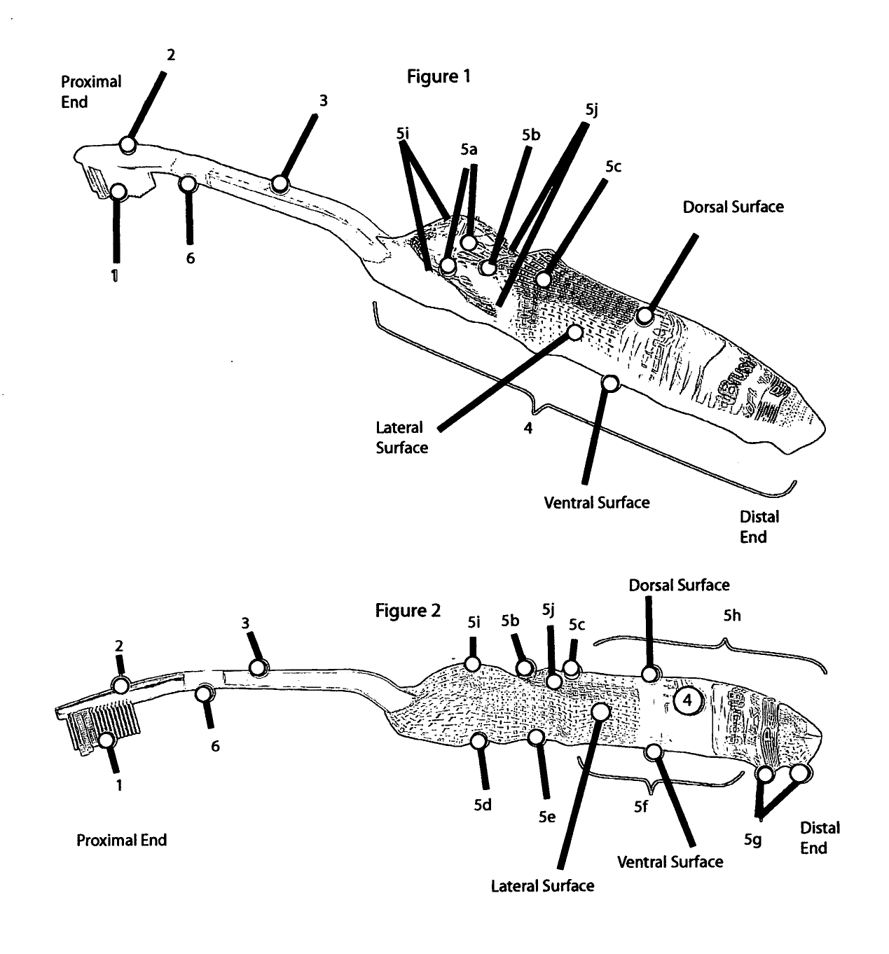

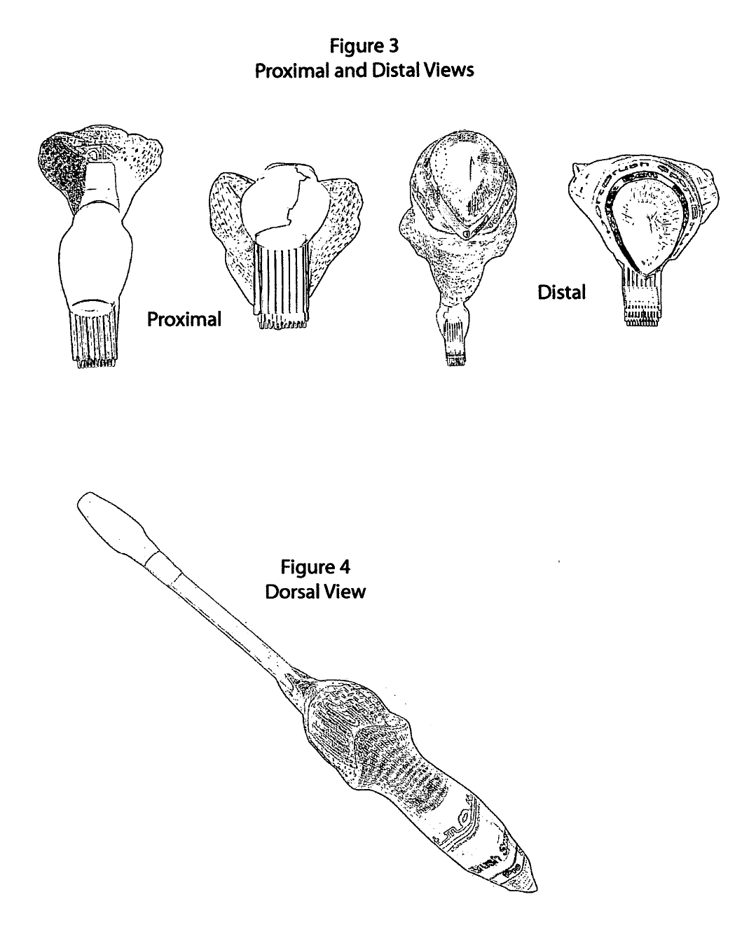

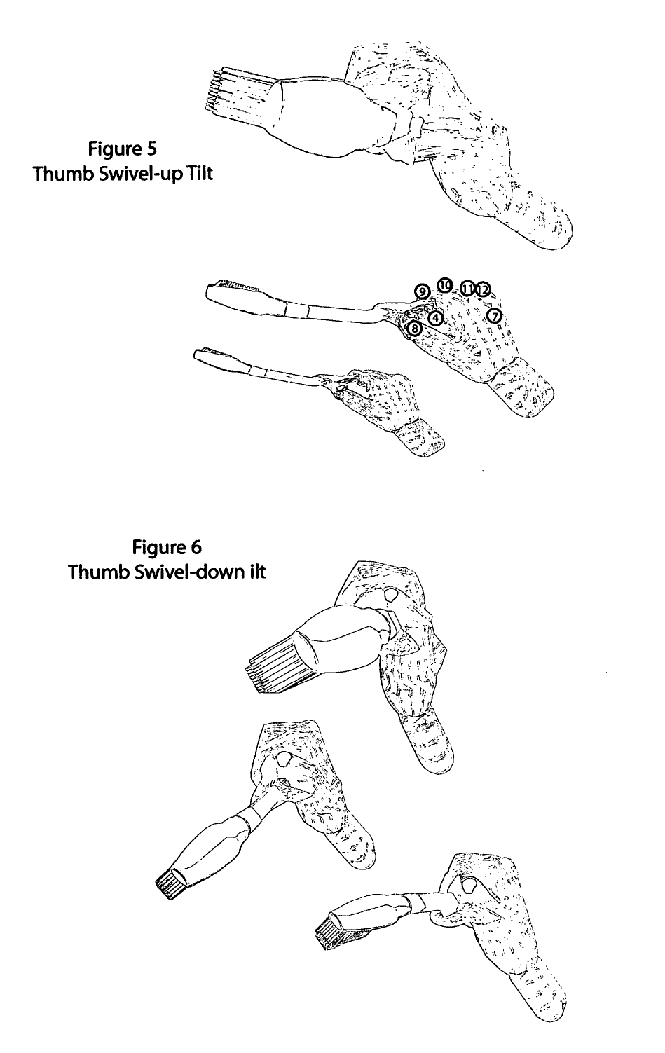

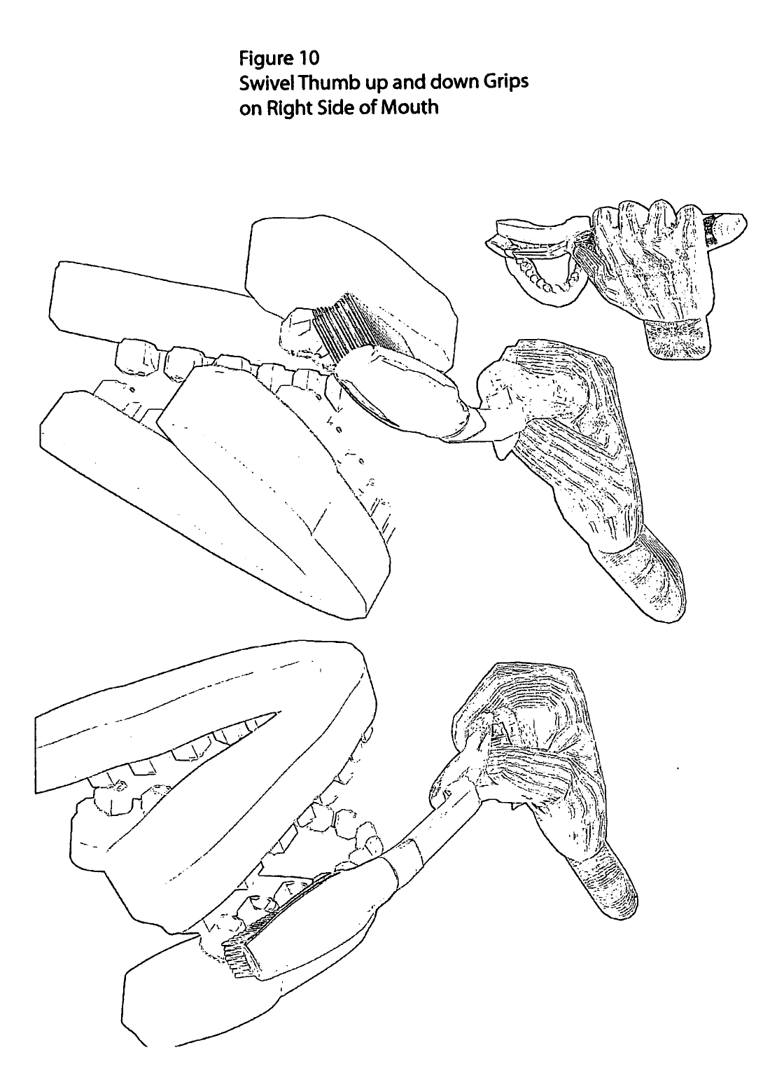

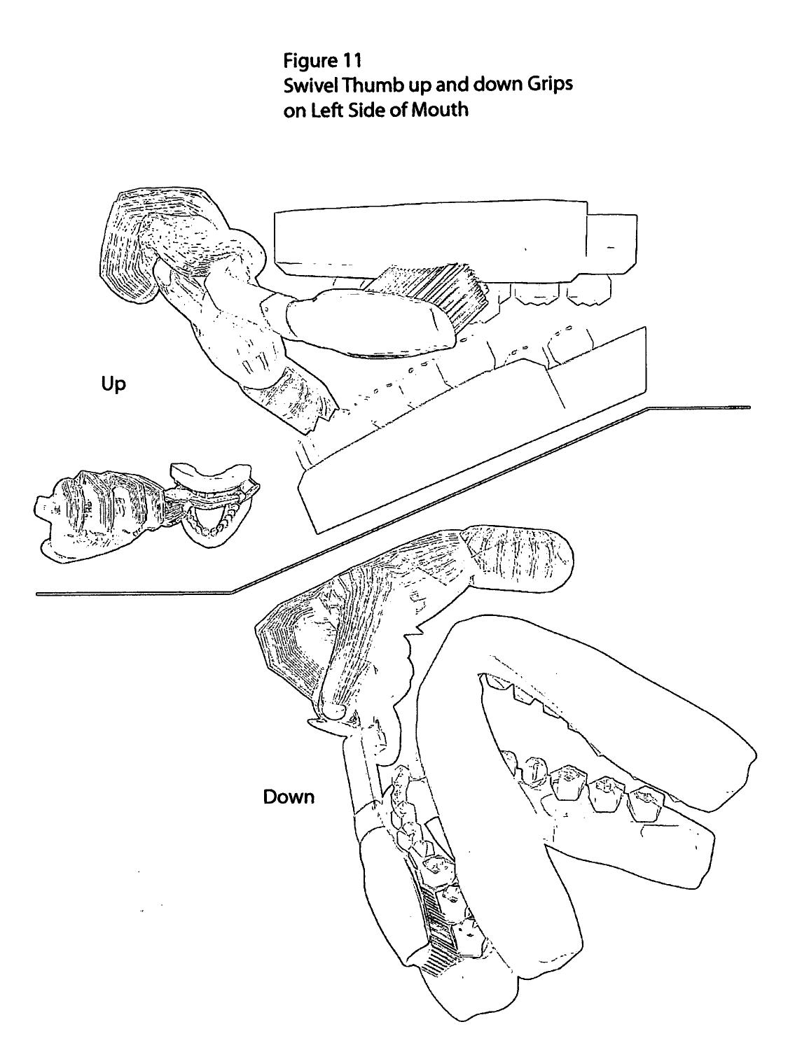

### 1) SWIVEL-THUMB (HITCH HIKER) FIGS. 5, 6, 10, 11

This is the main type of grip that affords the most functionality and fine control. It is also the main grip that almost effortlessly gets the bristles oriented 45 degrees into the gingival crevices surrounding the teeth in accordance with the Modified Bass brushing technique known in professional dental circles.

Tooth brushing seems to be a habitual and highly personal function learned haphazardly at an early age usually from people who know virtually zero about oral hygiene. Yet, many people stick with their own convoluted way of brushing, and may even believe they are performing it perfectly even though they are wearing out the sides of their teeth and gums. However, only a few types of grips and brushing routines make ergonomic and fitness sense. As an example, one cannot hold a tennis racquet any old which way and expect to play a serious game. There are only a couple specific ergonomic sports grips for tennis racquets and that is all. The same goes for a golf club, baseball bat, or virtually any other sporting device. Specific devices have been invented and continually refined for specific sports or fitness routines. The exact same concept applies to oral hygiene, which is better named dental fitness. Therefore, speaking as a dental fitness personal trainer with 18 years of professional experience, the safest and most effective dental fitness grip, without question, is the hitchhiker swivel-thumb grip for the dental fitness tooth-brushing device employing the multiple grip dental handle.

The swivel-thumb grip affords the most versatility. With a minimum of effort and great economy of motion, this type of grip allows one to flow through a dental fitness routine like an expertly choreographed martial arts exercise, wherein every movement anticipates and precipitates another flowing movement. The swivel-thumb grip allows the device to rotate 270 degrees about the long axis and 180 degrees about the short axis by simply swiveling the fingers and thumb a little bit. Combined with minimal wrist, arm, head, neck, and jaw movements, the range of motion needed for the fingers and hand is surprisingly small and easy for many disabled people to perform. Since the swivel-thumb grip is not a heavy-handed fist grip and the handle is deftly held mostly by the fingertips and thumb tip and palm, the grip imparts minimal pressure to the oral tissues to avoid tooth abrasion and gum recession automatically. Combined with a resilient, non-Hookian spring neck and soft, end-rounded bristles, an attached toothbrush becomes even safer. Further modified by flexing neck components, electronics, balancing, etc. in more advanced models, the handle can easily make almost any brush the safest, most effective and most user-friendly toothbrush on the market.

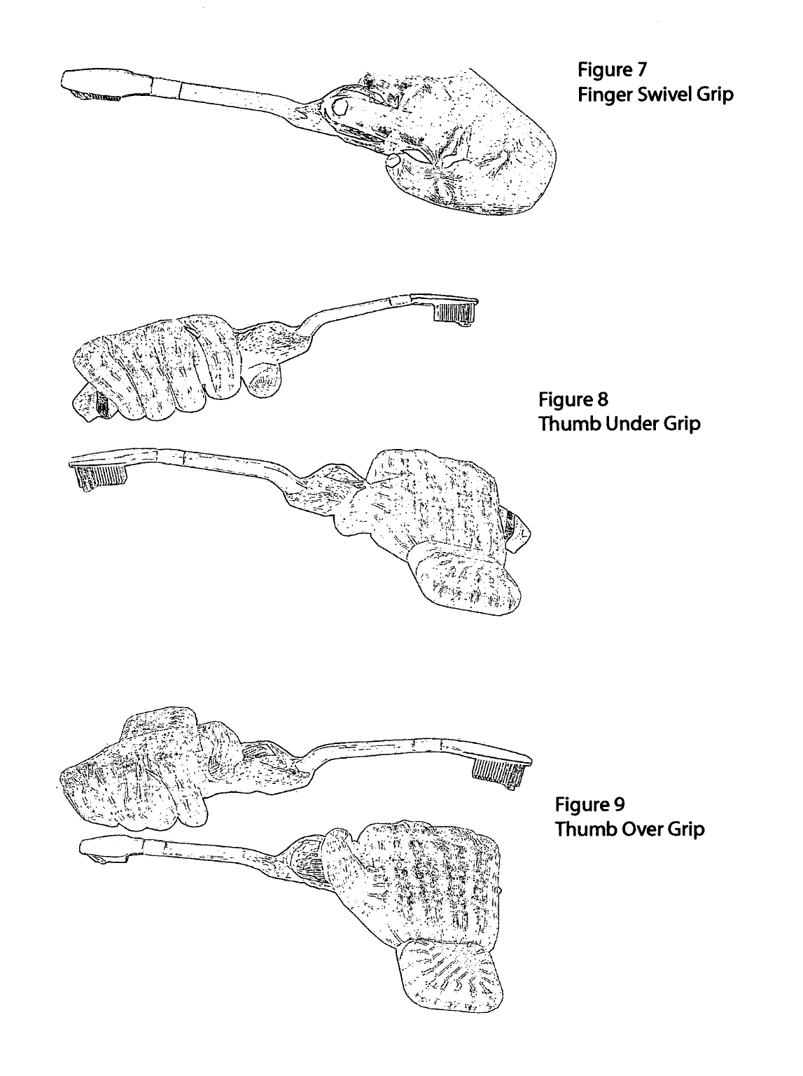

### 2) THE SWIVEL-FINGER GRIP FIG. 7

The Swivel-Finger Grip is a modification of the swivel-thumb grip mentioned above. It works about the same way as the swivel-thumb grip but has less range of motion.

### 3) THUMB-UNDER (FIST) FIG. 8

The Thumb Under grip is a primitive grip used often by children and people with limited cognition or mobility, or for most common toothbrushes on the market, because most toothbrushes are not ergonomically designed and are especially not designed for dental fitness. This grip is probably the most common cause of tooth abrasion and gum recession. At least with the current invention ergonomic handle, the thumb-under grip will be more comfortable and the user will not have to focus so much on grabbing and stabilizing the brush. As a result, the user should be able to pay more attention to a proper dental fitness routine and perform a safer brushing action in the process, even if holding the handle with a fist grip.

### 4) THUMB OVER FIGURE (HAND GRENADE) 9

The Thumb-over grip is a variant of the thumb-under grip, and the same things apply as with the thumb-under grip.

These are the four major tooth-brushing grips that helped determine the design and function of the present invention. Its unique utility is the result of its design, and its unique design is a result of its utility. Many other types of grips were tried on the handle and the handle works comfortably with the vast majority of them. In addition, it is recognized that there will be a need for child and adult sizes, just as child and adult toothbrushes already exist in the market.

### CLAIMS

Definitions of surfaces for better understanding of the claims:
Proximal: Located adjacent to the neck of a toothbrush socketed in the handle body
Distal: located 180 degrees opposite from the proximal end
Ventral: facing in the direction of the bristle side of a toothbrush neck socketed in the handle body
Dorsal: located 180 degrees opposite the ventral surface
Lateral: located on the sides of the handle, 90 degrees from the proximal, distal, dorsal, and ventral surfaces.

I claim:

1. A multiple gripping style handle for a dental fitness implement, oral hygiene device, or other household hand-held implement, said handle comprising:
a. an elongated body formed of a relatively stiff plastic with a non-slip elastomeric material, the body having a variable ovoid cross section that is bilaterally symmetrical in the long axis but asymmetrical in the short axis, said body having an exposed internal cavity to socket a toothbrush neck at the proximal end, and
b. an undulated main dorsal grip site at the proximal end of the body on the dorsal surface, wherein
i. said dorsal grip site includes a depressed center about the size of an average adult human thumb tip and partially surrounded on the proximal and both lateral sides by a raised half-oval rim that fades distally into the body at about the halfway point of the oval shape such that the depressed region surrounded by raised walls cradles a thumb, knuckle or forefinger and provides a means of resistance to lateral displacement of the handle body and a means of orienting the handle into proper brushing angles;
ii. said dorsal grip site includes a raised undulation in the long axis midline wherein the raised undulation begins at about the distance from the proximal end where the oval rim fades into the body and again cradles digits, maintains control, and further provides a means of orienting the handle for proper brushing;
iii. said dorsal grip site includes a horizontally oriented V-shaped rounded channel with its apex toward the proximal end, bounded by the aforementioned raised oval walls, depressed center and raised undulation such that the channel fades distally into the lateral surfaces and thus can accommodate either a thumb, a knuckle of a thumb going crosswise through the channel, a finger, or a finger knuckle going crosswise through the channel, thereby adding another means of superb control, resistance to displacement, flexibility of manipulation, as well as a means for allowing many types of gripping styles
c. a plurality of other surface indents including ventral surface indents that define ventral grip sites whereby when a user clenches the handle with the fingers of his/her hand, the internal region in the resultant fist conforms to the shape of the handle to provide a good grip, and the dorsal and ventral grip sites become engaged by the respective thumb and fingers corresponding to whatever gripping style the user chooses, so that excellent handle control is further enhanced by allowing the fingers and palm to gently flex and absorb excessive brushing forces

2. A multiple gripping handle as set forth in claim 1 wherein the internal cavity may house a toothbrush neck as well as weights, batteries, electronics, motors, oscillators, magnetorrheostatic fluid, springs, driveshafts, sensors, springs, tension adjusters, flexing necks, and all sorts of additional equipment to modify the device into an electric brush to or allow for balancing, extra stability, or additional features now known or in the future, capable of enhancing the handle's function.

3. A multiple gripping style handle for a dental fitness implement, oral hygiene device, or other household hand-held implement, said handle comprising:
a. an elongated body formed of a soft, non-slip elastomeric material with a non-slip coating, an antimicrobial additive, and having a variable ovoid cross section that is bilaterally symmetrical in the long axis but asymmetrical in the short axis, said body having an exposed internal cavity to envelop a toothbrush handle from the handle's proximal end, and
b. an undulated dorsal grip site at the proximal end of the body on the dorsal surface, wherein
c. an undulated main dorsal grip site at the proximal end of the body on the dorsal surface, wherein
i. said dorsal grip site includes a depressed center about the size of an average adult human thumb tip and partially surrounded on the proximal and both lateral sides by a raised half-oval rim that fades distally into the body at about the halfway point of the oval shape such that the depressed region surrounded by raised walls cradles a thumb, knuckle or forefinger and provides a means of resistance to lateral displacement of the handle body and a means of orienting the handle into proper brushing angles;
ii. said dorsal grip site includes a raised undulation in the long axis midline wherein the raised undulation begins at about the distance from the proximal end where the oval rim fades into the body and again cradles digits, maintains control, and further provides a means of orienting the handle for proper brushing;
iii. said dorsal grip site includes a horizontally oriented V-shaped rounded channel with its apex toward the proximal end, bounded by the aforementioned raised oval walls, depressed center and raised undulation such that the channel fades distally into the lateral surfaces and thus can accommodate either a thumb, a knuckle of a thumb going crosswise through the channel, a finger, or a finger knuckle going crosswise through the channel, thereby adding another means of superb control, resistance to displacement, flexibility of manipulation, as well as a means for allowing many types of gripping styles
d. a plurality of other surface indents including ventral surface indents that define ventral grip sites whereby when a user clenches the handle with the fingers of his/her hand, the internal region in the resultant fist conforms to the shape of the handle to provide a good grip, and the dorsal and ventral grip sites become engaged by the respective thumb and fingers corresponding to whatever gripping style the user chooses, so that excellent handle control is further enhanced by allowing the fingers and palm to gently flex and absorb excessive brushing forces
e. said handle body can be applied to most standard manual toothbrushes as an adapter to convert such brushes into dental fitness devices by sliding the handle of a standard toothbrush into the internal cavity of the body via the proximal opening on the handle, or
f. said soft handle body being molded directly onto a standard toothbrush

4. A means of developing a multiple gripping style dental handle by
a. applying a moldable substance to a dental implement
b. putting the implement through multiple dental-related functions
c. exposing the implement to multiple dental-related gripping styles
d. averaging out all the resultant deformations occurring to the moldable substance
e. refining said deformations into a finalized functional, ergonomic dental handle or other handheld implement design
f. further enhancing the handle's function by incorporating a textured, frictional, elastomeric, antimicrobial coating

5. A new method of oral hygiene called dental fitness whereby scientific principles of fitness, exercise physiology, ergonomics, sports design, nutrition, supplementation, paths of motion, ranges of motion, and other fitness-related concepts are applied to oral hygiene such that oral hygiene becomes safer, more effective, easier, simpler, and more understandable since it is viewed from a fitness perspective.
